(19) United States
(12) Patent Application Publication
(10) Pub. No.: US 2024/0278269 A1
(43) Pub. Date: Aug. 22, 2024

(54) SYSTEM AND METHOD FOR REFILLING A BOTTLE WITH LIQUID

(71) Applicant: TECHNIPLAST, LOUVIERS (FR)

(72) Inventors: Jean-Philippe LAMBOUX, LOUVIERS (FR); Loïc BOUET, LOUVIERS (FR)

(21) Appl. No.: 18/582,767

(22) Filed: Feb. 21, 2024

(30) Foreign Application Priority Data
Feb. 22, 2023 (FR) 2301626

(51) Int. Cl. B05B 11/00

(52) U.S. Cl. CPC B05B 11/0056

(57) ABSTRACT

A system for refilling a bottle to be refilled (R) with liquid from a source bottle (S) containing the liquid, comprising a pump (Ps) and a rod (t) for actuating the pump which has an open end (t1), the bottle (R) to be refilled comprising an opening (O) opposite the bottom and being equipped, in line with the opening, with a liquid transfer device (12) and an air removal device (14), the bottle (R) to be refilled being in an inverted position above the source bottle such that:
the liquid transfer device (12) is in contact with the open end (t1) and is configured to allow the passage of liquid from the source bottle (S) to the bottle (R) under successive actions of downward vertical pressure on the bottle (R) and release of the pressure; and
the air removal device (14) is configured to allow air to be removed from the inside of the bottle to be refilled to the outside of it.

### TECHNICAL FIELD

The present invention relates to the field of refilling with liquid, of a bottle to be refilled from a source bottle called refill. The present invention relates more particularly to a system for refilling a bottle to be refilled with liquid from a refill and, also, to a method for refilling a bottle to be refilled with liquid from a refill.

### PRIOR ART

Different systems are known for refilling a bottle to be refilled with liquid from a source bottle.

However, there is a need to design a new liquid refill system which is simple to use from the user's viewpoint in order to simply and efficiently refill a bottle to be refilled with a liquid from a liquid refill, when the bottle to be refilled is equipped either with a removable pump or with a cap to close it, without introducing a filling interface between the bottle to be refilled and the refill.

### DISCLOSURE OF THE INVENTION

The subject of the invention is thus a system for refilling a bottle to be refilled with liquid from a source bottle containing the liquid, the source bottle comprising a pump and a rod for actuating the pump which has an open end, the bottle to be refilled comprising a bottom and an opening opposite the bottom and being equipped, in line with the opening, with a liquid transfer device and an air removal device, the bottle to be refilled being in an inverted position above the source bottle such that:
on the one hand, the liquid transfer device is in contact with the open end of the pump actuating rod and is configured to allow the passage of liquid from the source bottle to the bottle to be refilled under successive actions of downward vertical pressure on the bottle to be refilled and release of the pressure,
and, on the other hand, the air removal device is configured to allow air to be removed from the inside of the bottle to be refilled to the outside of it.

The above-mentioned system makes it possible to simply and efficiently transfer liquid contained in the source bottle to the inverted bottle which is to be refilled. The procedures for implementing such a system are particularly simple for the user since they only need to press on the inverted bottle which is to be refilled to convey liquid inside the latter via the pump of the source bottle. Prior to this operation, the user simply installs the liquid transfer device and the air removal device on the opening of the bottle to be refilled, after having removed either the removable pump with which this bottle is equipped (this pump is used for the conventional operation of the bottle to be refilled during distribution/diffusion of the liquid contained in this bottle), or a cap closing it. Also, the device disposed on top of the pump of the source bottle has to be removed (overall this device is a liquid diffusion or distribution device) when the source bottle is equipped with such a device, in order to get access to the internal mechanism of the pump of the latter, in particular to the actuating rod. None structural modification of the source bottle is thus to be envisaged, except tthe above device which has to be removed when the bottle is equipped with such a device. This installation therefore does not question the conception of the bottle to be refilled, as it would be the case if the installation were at the level of the bottom of the bottle to be refilled. The liquid transfer device and the air removal device are only mounted/attached on the bottle to be refilled, not on the source bottle, which makes easier the implementation of the system. The liquid transfer device and the air removal device are usually removably mounted/attached to the bottle to be refilled, in order for these devices to be removed when the bottle to be refilled has been refilled with liquid (and, for example, for putting in place the removable pump which has been removed beforehand so as to use the bottle to be refilled in a conventional manner). In the aforementioned system, a filling interface is not introduced as an intermediate part between the bottle to be refilled and the refill. This system makes it possible to refill a smaller bottle (e.g., 20 ml) that can be used during transport, with a source bottle of larger capacity (e.g.: 100 ml) which is not transported. To be noted that air contained in the bottle to be refilled and that is evacuated to the outside of it when liquid is transferred from the source bottle to the bottle to be refilled is evacuated to the outside of the liquid refilling system, i.e. also outside to the bottle source. Air that is evacuated is thus transmitted to the immediate environment of the system (ambient air surrounding the system).

According to other possible characteristics:
the liquid transfer device is a valve device which is capable of occupying, on the one hand, an open position in which liquid can be transferred through said device to refill the bottle to be refilled and, on the other hand, a closed position preventing any passage of liquid;
the air removal device comprises a conduit open at its two opposite ends, which comprises a first end disposed next to the liquid transfer device and communicating with the air outside the bottle to be refilled (air external to the system and therefore also to the source bottle), the conduit extending inside the bottle to be refilled to a second opposite end communicating with the interior of the bottle to be refilled;
the liquid transfer device and the air removal device are part of at least one part which is removably attached to the bottle to be refilled (the part is attached at the opening of the bottle to be refilled); said at least one part therefore integrates the two devices and is mounted on the bottle to be refilled, which allows the two devices to be simply placed on the bottle;
said at least one part is attached to the bottle to be refilled by screwing or snapping on;
said at least one part attached to the bottle to be refilled comprises a wall arranged opposite the opening of the bottle to be refilled and which bears the liquid transfer device and the air removal device;
the wall is pierced in its thickness in line with the first end of the air removal conduit;
the liquid transfer device comprises a contact zone oriented opposite the open end of the pump actuating rod and which is configured to come into sealed contact with said open end; the contact zone generally takes the form of a cavity or a receptacle used to receive in a sealed manner the open end of the pump actuating rod of the source bottle;
the contact zone takes the form of a cavity configured to come into sealed contact with the open end of the pump actuating rod which has an outer diameter comprised within a predetermined range of outer diameters. The cavity can be delimited by a wall of general frustoconical shape flared towards the open end of the rod and whose opening/inclination angle relative to the vertical can be between 5 and 40°.

The invention also relates to a method for refilling a bottle to be refilled with liquid comprising a bottom and an opening opposite the bottom, from a source bottle containing the liquid and equipped with a pump provided with an actuating rod, the method comprising the following steps:
attaching to the opening of the bottle to be refilled of a liquid transfer device and an air removal device,
inverting the bottle to be refilled thus equipped and positioning the liquid transfer device against an open end of the pump actuating rod of the source bottle,
applying downward vertical pressure on the bottle to be refilled so as to push the pump actuating rod inside the source bottle and releasing the pressure in order to transfer a quantity of liquid from the source bottle to the bottle to be refilled through the liquid transfer device, while the air present in the bottle to be refilled is evacuated outside this bottle via the air removal device.

The method has the same advantages as those mentioned above in relation to the system and will therefore not be repeated.

According to other possible characteristics:
the bottle to be refilled being equipped with a removable cap or a removable pump, the method comprises a step of removing the removable cap or the removable pump before attaching the liquid transfer device and the air removal device to the opening of the bottle to be refilled;
the source bottle is previously equipped with a diffusion/distribution device which is mounted on top of the pump and the method includes a preliminary step of removing the diffusion/distribution device in order to leave the open end of the pump actuating rod free to access.

### BRIEF DESCRIPTION OF THE DRAWINGS

Other characteristics and advantages will appear during the description which follows, given solely by way of non-limiting example and made with reference to the attached drawings, in which:

FIG. 1 is a schematic view in longitudinal section of a bottle to be refilled R provided with a pump according to one embodiment of the invention;

FIG. 2 is a schematic view in longitudinal section showing a first step of unscrewing the pump from the bottle to be refilled R of FIG. 1;

FIG. 3 is a schematic view in longitudinal section showing a second step of removing the pump from the bottle to be refilled R of FIG. 2;

FIG. 4 is a schematic view in longitudinal section showing a third step of installing a transfer part on the bottle to be refilled R of FIG. 3;

FIG. 5 is a schematic view in longitudinal section showing a fourth step of screwing the transfer part onto the bottle to be refilled R of FIG. 4;

FIG. 6 is a schematic view similar to FIG. 5 and showing an alternative embodiment of the part screwed onto the bottle to be refilled R of FIG. 4;

FIG. 7 is a partial schematic view of the upper part of the source bottle S provided with a diffuser;

FIG. 8 is a schematic view similar to FIG. 7 and showing a step of removing the diffuser;

FIG. 9 is a schematic view in longitudinal section of a complete refilling system according to one embodiment of the invention;

FIG. 10 is an enlarged partial schematic view of the system of FIG. 9;

FIG. 11 is an enlarged schematic view of part of the system of FIG. 10;

FIG. 12A is a partial schematic view similar to FIG. 11 and showing a cavity for receiving a first open end of the rod according to an alternative embodiment;

FIG. 12B is a partial schematic view similar to FIG. 11 and showing the reception cavity of FIG. 12A to accommodate a second open end of the rod according to an alternative embodiment;

FIG. 13A is a partial schematic view similar to FIG. 11 and showing an alternative embodiment of a liquid transfer device in the closed position;

FIG. 13B is a partial schematic view of the alternative embodiment of the liquid transfer device of FIG. 13A in the open position;

FIG. 14 is a schematic view in longitudinal section of a refillable bottle R provided with a cap according to another embodiment of the invention.

### DESCRIPTION OF THE EMBODIMENTS

The invention which is described below with reference to the attached drawings relates in particular to a system for refilling a bottle or container with liquid and an associated method. Generally, the bottle to be refilled has already been used to dispense liquid such as fragrance or other liquid that has been consumed and the bottle must therefore be refilled insofar as it is empty or nearly empty.

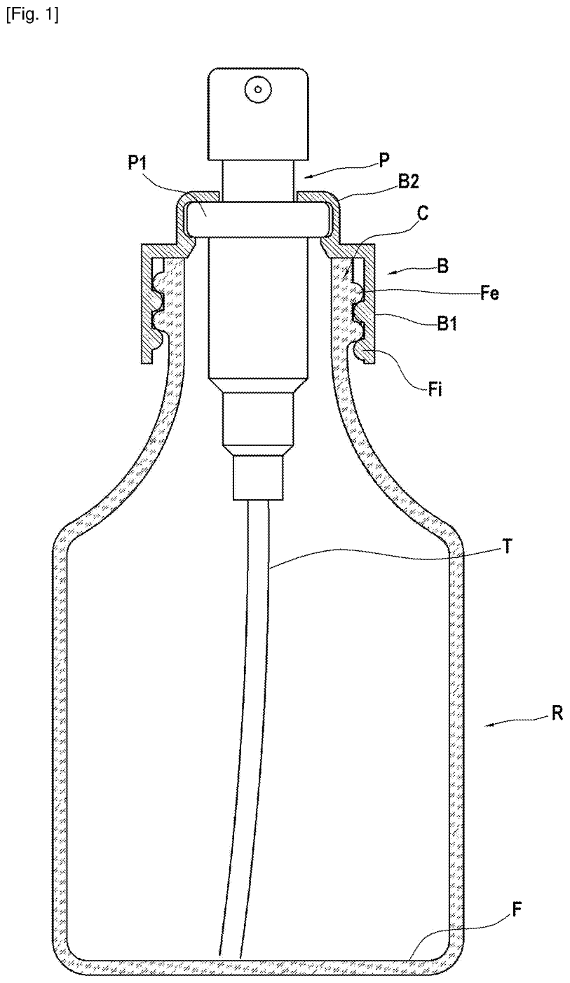

FIG. 1 represents a bottle R to be refilled with liquid which, here, is provided with a removable pump P mounted on the bottle by means of a ring B which is removably attached to the bottle R. In this example the ring B is provided with an internal thread Fi which is screwed onto an external thread provided on the external surface of the neck C of the bottle. Part B1 of the ring B surrounding the neck C is surmounted by a part B2 which is configured to grip a part P1 of enlarged diameter of the pump P, thus making it possible to maintain the pump in a fixed axial position relative to the bottle R. The pump P is conventionally equipped with a dip tube T which extends inside the bottle R to the bottom F thereof.

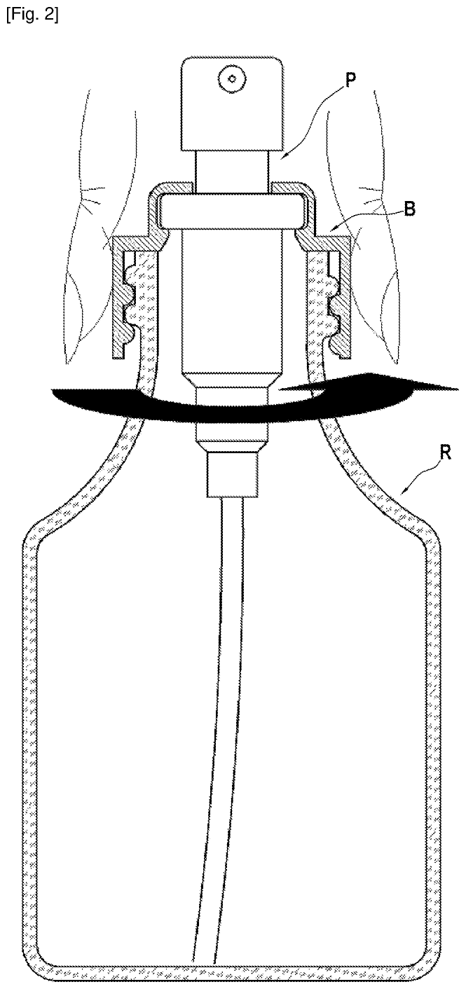

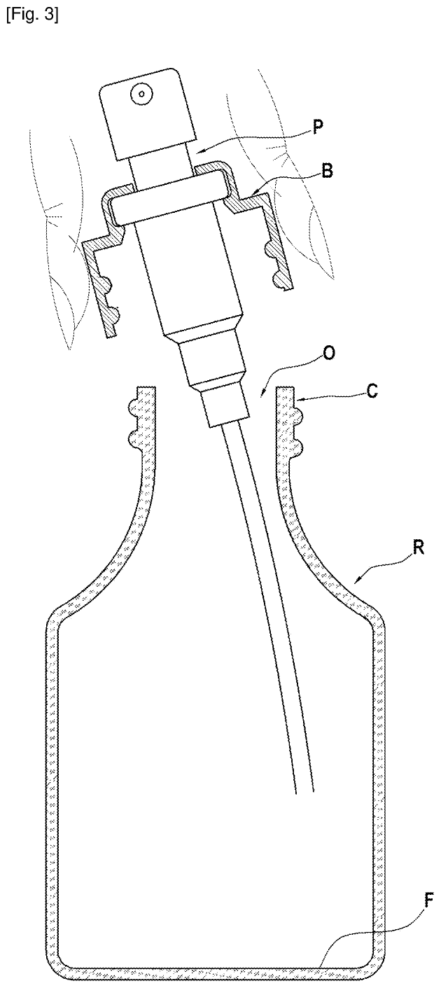

The user wishing to refill the bottle R with liquid must first remove the pump P. To do so, they unscrew the ring B using one hand (FIG. 2) and remove the assembly formed by the pump and the ring secured to the latter (FIG. 3), thus releasing the upper opening O of the bottle which is delimited externally by the neck C of the bottle, and which is disposed opposite the lower bottom F of which the structure is not modified.

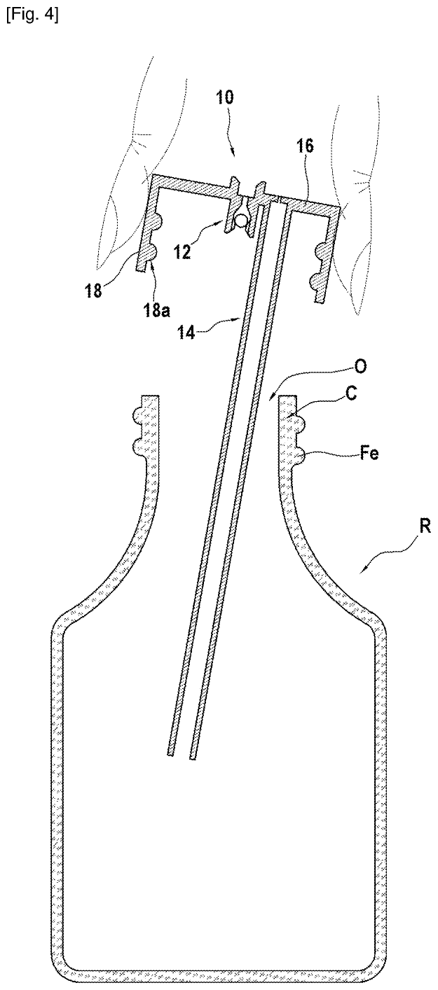

As shown in FIG. 4, the user then manually grasps between their fingers (two fingers are enough) a part 10 which integrates, on the one hand, a liquid transfer device 12 and, on the other hand, an air removal device 14. In this example, for the sake of simplicity, part 10 and the two devices are in one piece and for example manufactured by injection moulding.

The part 10 which can be considered to be a transfer ring comprises here a body which has a generally cylindrical shape of a cap or stopper comprising a first substantially flat wall 16, for example in the shape of a disc and a second substantially cylindrical wall 18 which is extends perpendicularly to the first wall 16, from the external periphery of the latter, in the form of a skirt. The second wall 18 carries an internal thread 18a on its internal surface to cooperate with the external thread Fe of the neck C of the bottle to be refilled R. The first wall 16 bears the two devices 12 and 14 which are arranged next to one another. These devices will be described later.

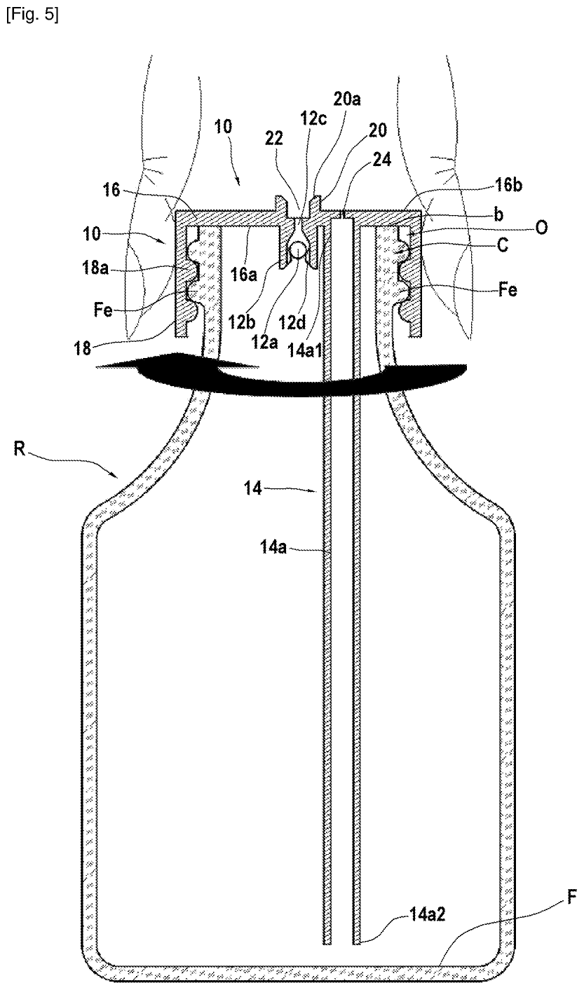

As shown in FIG. 5, the user introduces the two devices borne by the central part of the part 10 into the opening O of the bottle to be refilled R and screws the part onto the neck C of the bottle via the respective threads 18. At the end of screwing, the first wall 16 is held firmly against the upper edge b of the neck C of the bottle by means of a peripheral part of this wall 16, while the central part of this wall is arranged opposite the opening O of the bottle. Alternatively, part 10 can be provided with snapping members intended to snap onto the neck of the bottle to be refilled, for example on a lower edge of the neck.

Generally, the liquid transfer device 12 can be a valve device which is capable of occupying, on the one hand, an open position in which liquid can be transferred through said device to refill the bottle to be refilled R and, on the other hand, a closed position preventing any passage of liquid.

In FIG. 5, the device 12 is of the ball valve type. A ball 12a is trapped in a cage 12b which extends axially from a through orifice 12c provided in the first wall 16 at a distance from it (on the internal face 16a of the first wall 16 facing the opening O), in the same direction as skirt 18. The cage 12b is shaped so as to allow axial movement of the ball 12a between, on the one hand, a low position, shown in FIG. 5, where the ball is retained axially under the effect of gravity by a section of reduced passage 12d of the cage arranged opposite the orifice 12c but which is perforated axially so as to allow liquid to pass through (in this position the ball is spaced from the orifice 12d passing through the wall 16) and, on the other hand, a high position in which the ball 12a is pressed against the orifice 12c and closes it.

As shown in FIG. 5, the wall 16 also comprises on the side of its external face 16b an arrangement forming a receptacle for receiving one end of a rod for actuating a pump of a source bottle as will be seen below. This arrangement comprises a substantially cylindrical peripheral edge 20 which extends axially away from the external face 16b, and which externally delimits a central zone 22 (contact zone) forming a cavity or receptacle for receiving a pump rod. In this example, the cavity 22 is cylindrical in shape and the edge 20 has a flared shape (e.g., frustoconical) on the inner edge in order to facilitate the approximation and engagement of the pump rod in the cavity. The cavity 22 can encroach on a portion of the thickness of the wall 16 and communicates through the bottom of the cavity with the through orifice 12c.

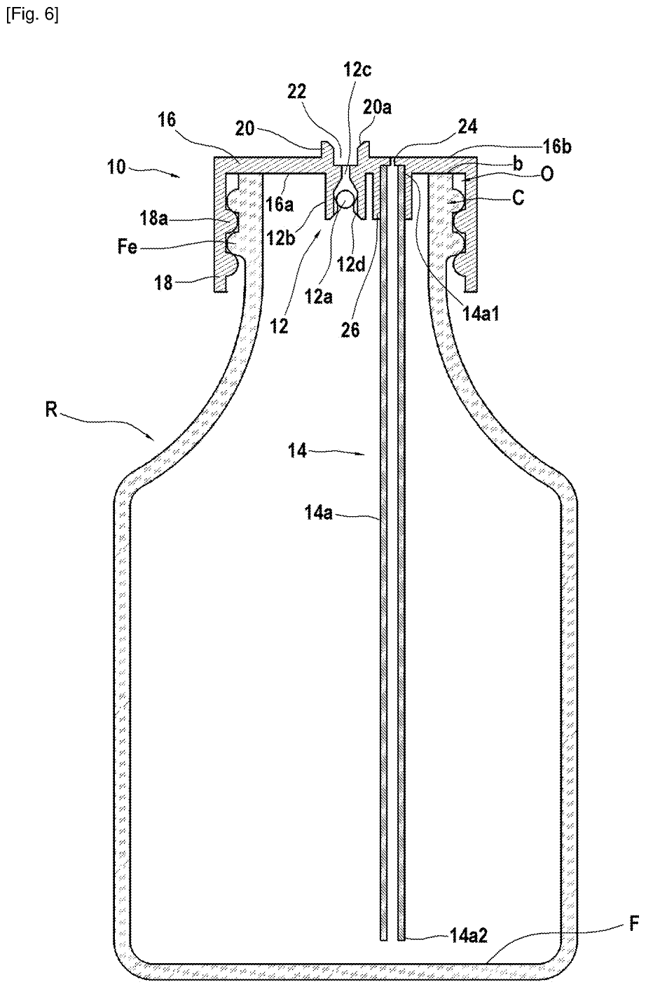

For its part, the air removal device 14 comprises a hollow conduit 14a open at its two opposite ends, which comprises a first end 14a1 disposed next to the liquid transfer device 12 and communicating with a hole 24 passing through the first wall 16 and opening onto the exterior of the bottle. The conduit 14a extends inside the bottle to be refilled R to a second opposite end 14a2 communicating with the interior of the bottle to be refilled. Here the second opposite end 14a2 is positioned near the bottom F. In a variant embodiment illustrated in FIG. 6, the internal face 16a of the first wall is shaped so as to include a hollow chimney 26 which extends axially parallel to the skirt 18 away from the internal face 16a, around the hole 24 and which is dimensioned to receive a terminal portion of the conduit 14a including the end 14a1. The conduit 14a thus fitted into the chimney is held firmly in position. In this variant, the air removal conduit is attached to the transfer part 10.

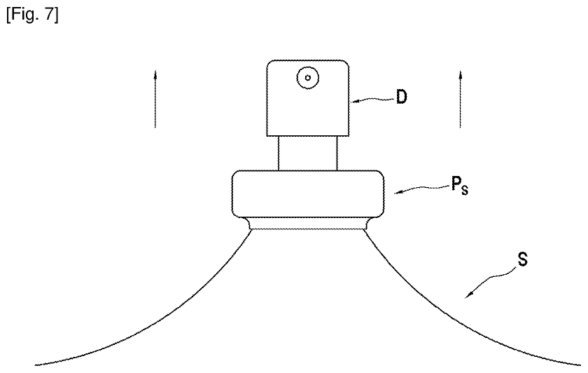

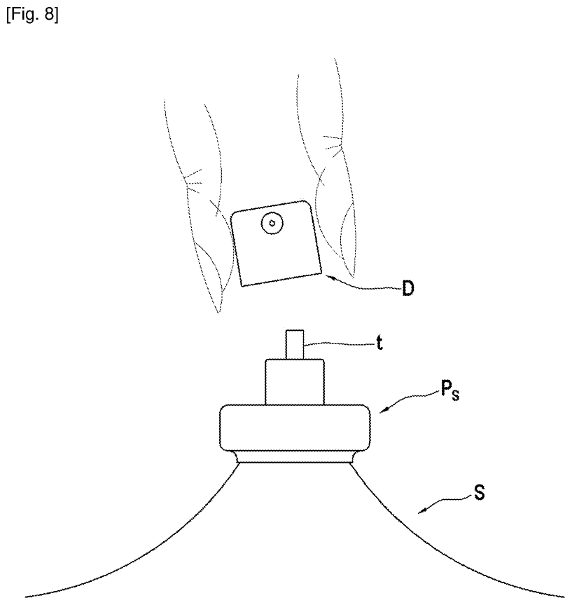

FIGS. 7 and 8 illustrate two successive steps carried out on a source bottle S (refill) of conventional type filled with liquid (for example with a capacity of 80 or 100 ml) which includes a pump Ps mounted on the bottle and a diffuser D (liquid diffusion or distribution device) mounted on top of the pump. The distribution of liquid is conventionally carried out by pressing on the diffuser D, which has the effect of pressing the pump, opening the internal valve mechanisms of the pump and suctioning liquid via a dip tube arranged at the inside the bottle.

In FIG. 8, the user removes the diffuser D to reveal the actuating rod t of the pump Ps and more particularly its open end. None modification of the structure of the source bottle is necessary (except removal of the diffuser D) to proceed to refilling or recharging the bottle to be refilled. Only the bottle to be refilled R is temporary equipped with a liquid transfer device 12 and an air removal device 14 at the conventional opening O of this bottle.

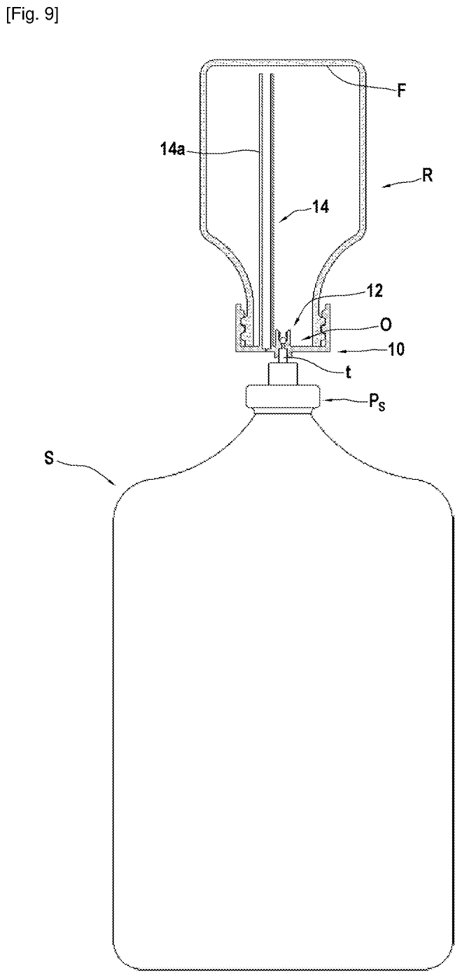

The bottle to be refilled R of FIG. 5 is then inverted, the part 10 closing the opening O being placed below the bottom F of the bottle. The bottle R is positioned above the source bottle S in such a way that the liquid transfer device 12 is in contact with the open end of the actuating rod t (FIG. 9).

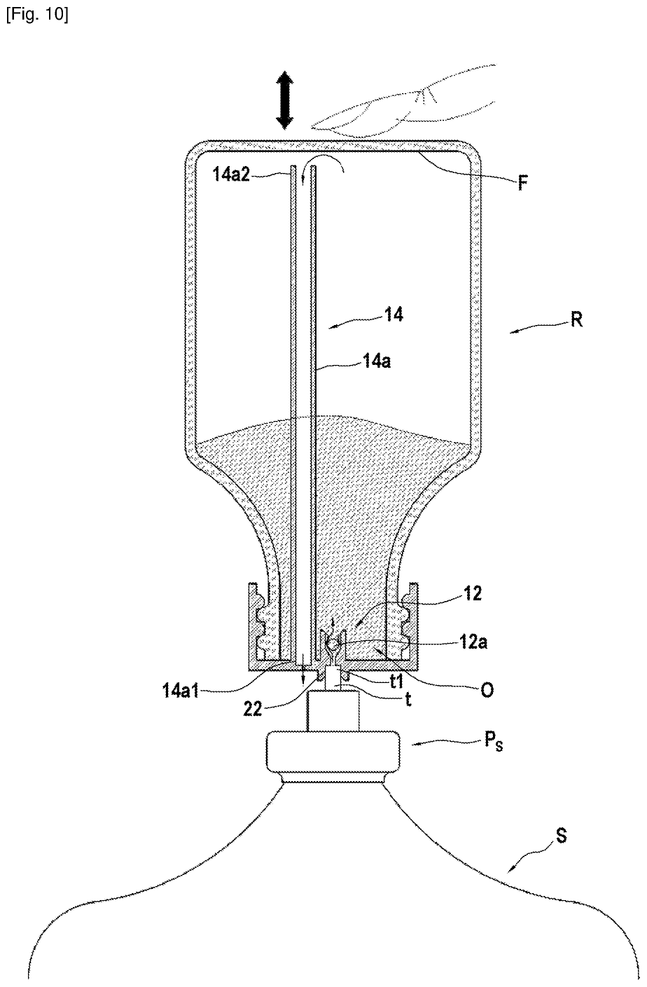

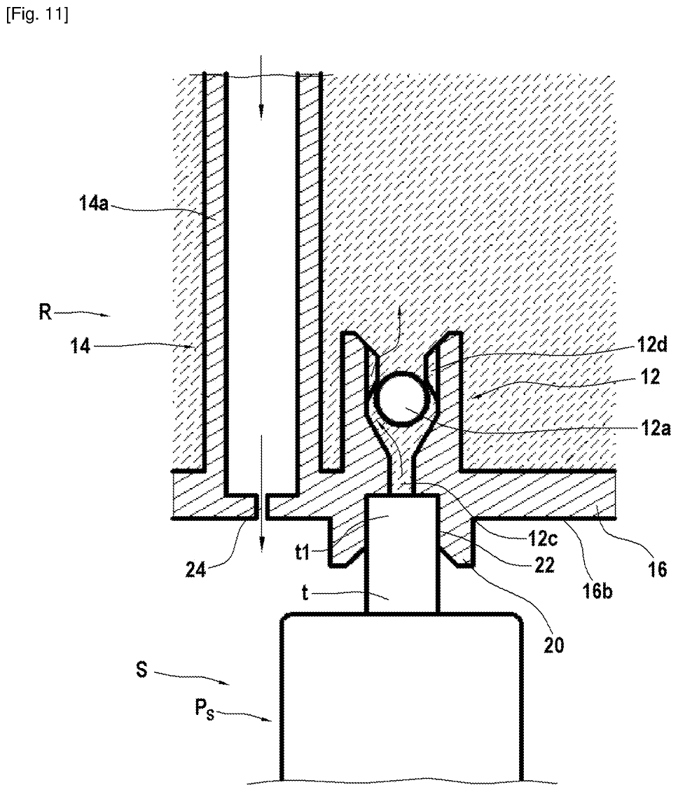

FIG. 10 is an enlarged partial view of the system shown in FIG. 9 and which is composed of the refill bottle R equipped with the transfer part or ring 10 and the source bottle S. FIG. 11 is an even more enlarged partial view showing essentially the operation of the two devices 12 and 14 in relation to the actuating rod t and the air outside the bottle R.

More particularly, the open end t1 of the actuating rod t is engaged in the opposite cavity 22 (contact zone) in order to come into sealed contact with the latter. The dimensions of the cavity 22 are adapted to the dimensions (outer diameter) of the end t1 of the rod to obtain a tight contact.

As illustrated in FIG. 10, when the user performs a pumping action on the bottle to be refilled R, that is to say when they perform successive actions of downward vertical pressing on the bottle to be refilled R, so as to press the actuating rod t of the pump Ps inside the source bottle S, and releasing the pressure (as indicated by the double vertical arrow in the figure), the user implements the source bottle in such a conventional manner in order to extract liquid (except that the diffuser used in conventional use has been removed): liquid contained in the bottle is thus conveyed (from bottom to top) through the pump Ps whose internal valves are open to the open end t1 of the actuating rod. The liquid conveyed under pressure (due to the pumping action) passes through the orifice 12c and lifts the ball 12a which moves away from the valve seat and abuts against the reduced passage section 12d (open valve). The liquid flows axially (here vertically) in the passage and passes through the open valve to enter the bottle to be refilled and fill it, as indicated by the vertical arrow. Liquid (a given quantity or dose) is thus transferred from the source bottle to the bottle to be refilled, through the liquid transfer device, following the user's pumping action. To continue filling the bottle R, the user must repeat the pumping actions as described above.

While a quantity of liquid is transferred from the source bottle to the bottle to be refilled through the liquid transfer device, as explained above, air present in the bottle to be refilled is exhausted outside the bottle (and the system formed by the two bottles) through the air removal device. More particularly, as illustrated in FIGS. 10 and 11, under the action of the introduction of the liquid into the bottle (liquid pressure) air is forced to enter the conduit 14a through the upper end 14a2 and circulates inside the conduit to the lower opposite end 14a1 where it passes through the hole 24 to be evacuated into the outside air surrounding the bottle (to be noted that air exiting the bottle to be refilled R is not reintroduced in the source bottle). This air circulation continues as long as liquid is transferred to the bottle. The user can stop the refilling process whenever they want.

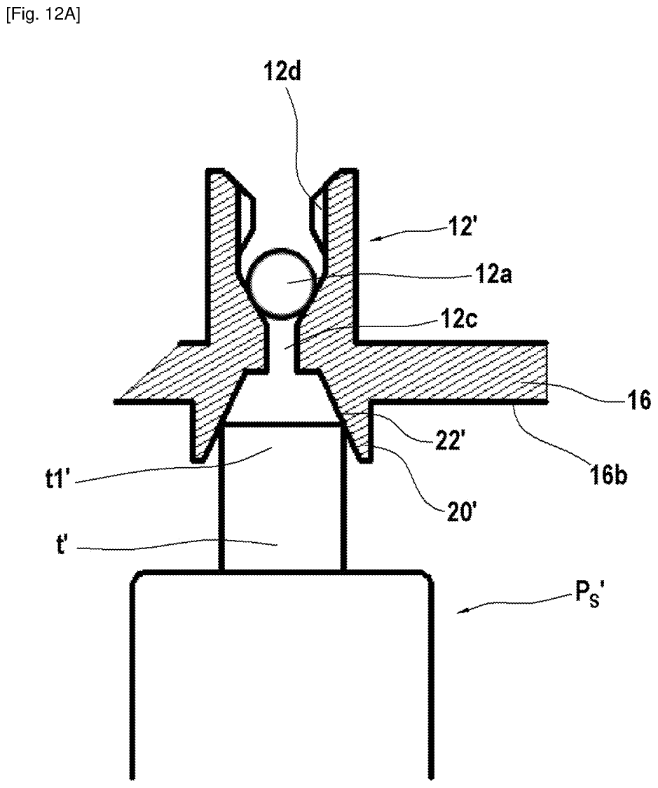

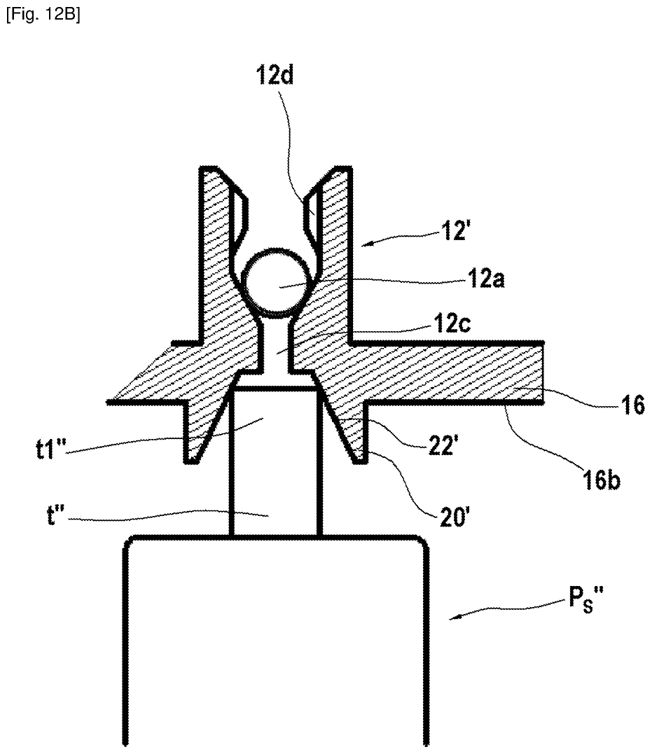

FIGS. 12A-B illustrate a variant embodiment in which the liquid transfer device of the previous figures has been modified in its external part (contact zone) intended to receive the open end of the pump actuating rod Ps′ from the source bottle.

In this variant, the contact zone located on the external face 16b of the wall 16 takes the form of a cavity 22′ configured to come into sealed contact with the open end t1′ (FIG. 12A) or t1″ (FIG. 12B) of the pump actuating rod Ps′. This cavity 22′ which is delimited by the peripheral edge 20′ is flared, frustoconical here, so as to be able to accommodate, in a sealed manner, the outer diameters of the actuating rods comprised within a predetermined range of outer diameters. In FIG. 12A, an open end t1′ of rod t′ having an enlarged outer diameter is shown in contact with the flared internal surface of cavity 22′. The circular contact here is sealed against the outside (the weight of the bottle R on the end t1′ contributes to ensuring fluid tightness), so that the liquid emerging from the end t1′ penetrates under pressure directly into the orifice 12c, then passes through the open valve, without any leaking of liquid to the outside and without outside air penetrating into the cavity 22′. FIG. 12B shows that an open end t1″ of rod t″ of pump Ps″ having a reduced outer diameter can also come into sealed contact with the flared internal surface of cavity 22′. The frustoconical shape of the cavity 2′ is defined, for example, by a cone angle comprised between 5 and 40° relative to the vertical.

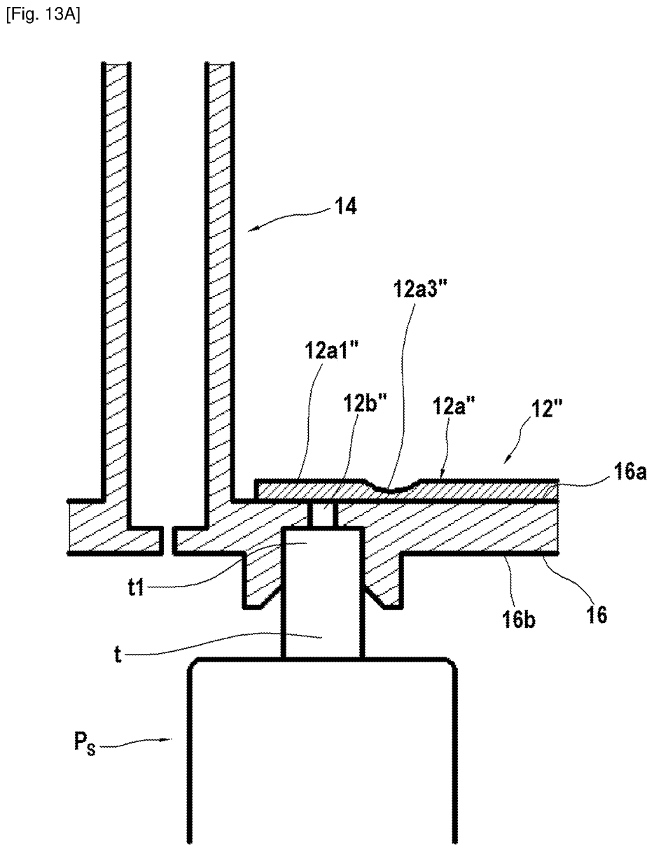

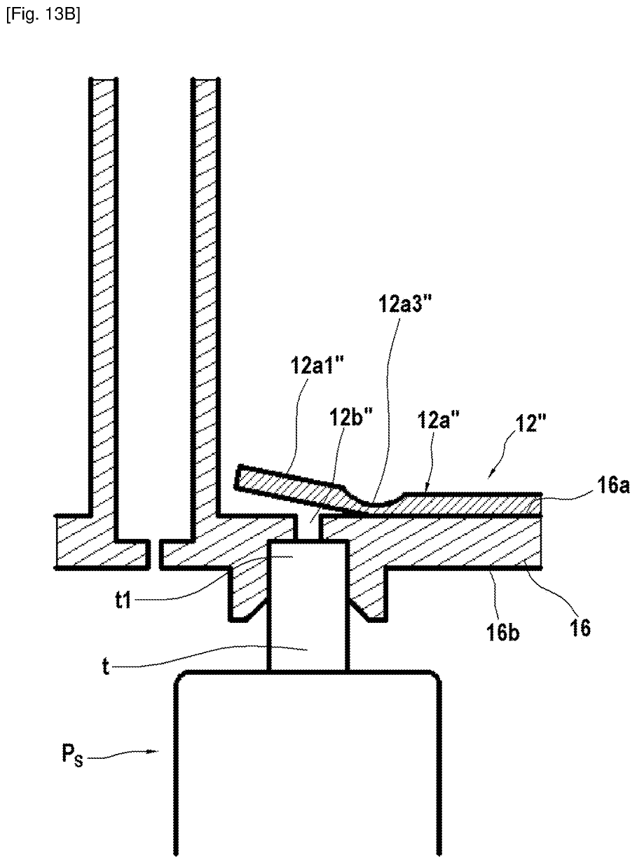

FIGS. 13A-B illustrate a variant embodiment in which the liquid transfer device 12″ is also a valve device which is able to occupy, on the one hand, an open position in which liquid can be transferred through said device for refilling the bottle to be refilled and, on the other hand, a closed position preventing any passage of liquid. However, here, the device does not include a ball but rather a blade 12a″ which is mounted against the internal face 16a of the wall and whose distal end 12a1″ is disposed, at rest (valve in the closed position preventing liquid transfer), against the through orifice 12b″ used for the passage of liquid (FIG. 13A). The blade 12a″ is attached (for example by gluing) against the internal face 16a over a part 12a2″ of its length and the remaining part comprises a thinned portion 12a3″ and the free distal end 12a1″. At the free distal end 12a1″, the thinned portion 12a3″ provides, flexibility (capacity to deform elastically repeatedly over time without deterioration) which allows it to move in flexion (by rising as indicated in FIG. 13B) under the action of an ascending liquid flow leaving the open end t1 (valve in the open position for the transfer of the liquid). Everything described regarding the previous mode and variants also applies here. It should also be noted that the cavity receiving the open end of the rod t for actuating the pump of the source bottle can also take the shape of FIGS. 12A-B.

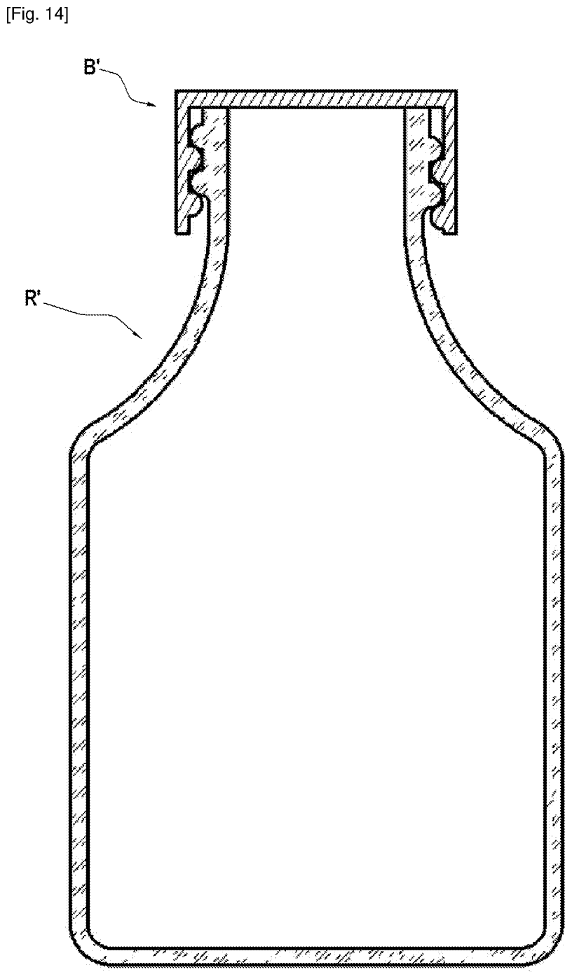

As shown in FIG. 14, the refill bottle R′ can alternatively be equipped with a removable cap B′ which is, here, screwed onto the neck of the bottle. To refill the contents of this bottle as indicated above, it suffices to remove this cap by unscrewing it, then insert the transfer part or ring 10 as indicated in FIGS. 4 and 5 described above. The preceding description also applies to bottle R′.

1. A system for refilling a bottle to be refilled with liquid from a source bottle containing the liquid, the source bottle comprising a pump and a rod for actuating the pump which has an open end, the bottle to be refilled comprising a bottom and an opening opposite the bottom and being equipped, in line with the opening, with a liquid transfer device and an air removal device, the bottle to be refilled being in an inverted position above the source bottle such that:
on the one hand, the liquid transfer device is in contact with the open end of the pump actuating rod and is configured to allow the passage of liquid from the source bottle to the bottle to be refilled under successive actions of downward vertical pressure on the bottle to be refilled and release of the pressure,
and, on the other hand, the air removal device is configured to allow air to be removed from the inside of the bottle to be refilled to the outside of it.

2. A system for refilling a bottle to be refilled with liquid according to claim 1, characterized in that the liquid transfer device is a valve device which is able to occupy, on the one hand, an open position in which liquid can be transferred through said device for refilling the bottle to be refilled and, on the other hand, a closed position preventing any passage of liquid.

3. A system for refilling a bottle to be refilled with liquid according to claim 1, characterized in that the air removal device comprises a conduit open at its two opposite ends, which comprises a first end disposed next to the liquid transfer device and communicating with the air outside the bottle to be refilled, the conduit extending inside the bottle to be refilled to a second opposite end communicating with the inside of the bottle to be refilled.

4. A system for refilling a bottle to be refilled with liquid according to claim 1, characterized in that the liquid transfer device and the air removal device form part of at least one part which is removably attached to the bottle to be refilled.

5. A system for refilling a bottle to be refilled with liquid according to claim 4, characterized in that said at least one part is attached to the bottle to be refilled by screwing or snap-fastening.

6. A system for refilling a bottle to be refilled with liquid according to claim 4, characterized in that said at least one part attached to the bottle to be refilled comprises a wall arranged opposite the opening of the bottle to be refilled and which bears the liquid transfer device and the air removal device.

7. A system for refilling a bottle to be refilled with liquid according to claim 5, characterized in that said at least one part attached to the bottle to be refilled comprises a wall arranged opposite the opening of the bottle to be refilled and which bears the liquid transfer device and the air removal device.

8. A system for refilling a bottle to be refilled with liquid according to claim 3, characterized in that the wall is pierced in its thickness in line with the first end of the air removal conduit.

9. A system for refilling a bottle to be refilled with liquid according to claim 1, characterized in that the liquid transfer device comprises a contact zone oriented opposite the open end of the pump actuating rod, and which is configured to come into sealed contact with said open end.

10. A system for refilling a bottle to be refilled with liquid according to claim 9, characterized in that the contact zone takes the form of a cavity configured to come into sealed contact with the open end of the pump actuating rod which has an outer diameter comprised within a predetermined range of outer diameters.

11. A method for refilling a bottle to be refilled with liquid comprising a bottom and an opening opposite the bottom, from a source bottle containing the liquid and equipped with a pump provided with an actuating rod, the method comprising the following steps:
attaching to the opening of the bottle to be refilled of a liquid transfer device and an air removal device,
inverting the bottle to be refilled thus equipped and positioning the liquid transfer device against an open end of the pump actuating rod of the source bottle,
applying downward vertical pressure on the bottle to be refilled so as to push the pump actuating rod inside the source bottle and releasing the pressure in order to transfer a quantity of liquid from the source bottle to the bottle to be refilled through the liquid transfer device, while the air present in the bottle to be refilled is evacuated outside this bottle via the air removal device.

12. A method for refilling a bottle to be refilled with liquid according to claim 11, characterized in that the bottle to be refilled being equipped with a removable cap or a removable pump, the method comprises a step of removing the removable cap or the removable pump before attaching, on the opening of the bottle to be refilled, the liquid transfer device and the air removal device.

13. A method for refilling a bottle to be refilled with liquid according to claim 11, characterized in that the source bottle is previously equipped with a diffusion device which is mounted on top of the pump and the method comprises a preliminary step of removing the diffusion device in order to leave free access to the open end of the pump actuating rod.

14. A method for refilling a bottle to be refilled with liquid according to claim 12, characterized in that the source bottle is previously equipped with a diffusion device which is mounted on top of the pump and the method comprises a preliminary step of removing the diffusion device in order to leave free access to the open end of the pump actuating rod.
